(19) United States
(12) Patent Application Publication
(10) Pub. No.: US 2023/0274283 A1
(43) Pub. Date: Aug. 31, 2023

(54) METHOD AND SYSTEM FOR TRANSFER OF OWNERSHIP OF NFT (NON-FUNGIBLE TOKEN) UPON REFUND TRANSACTION IN PAYMENT NETWORK

(71) Applicant: MASTERCARD INTERNATIONAL INCORPORATED, Purchase, NY (US)

(72) Inventors: Dmytro KRYVOSHEI, Edison, NJ (US); Rakesh YADAV, Cape Elizabeth, ME (US); Biser Mitkov DIMITROV, New York, NY (US)

(73) Assignee: MASTERCARD INTERNATIONAL INCORPORATED, Purchase, NY (US)

(21) Appl. No.: 17/667,246

(22) Filed: Feb. 8, 2022

(51) Int. Cl. G06Q 20/40; G06Q 20/22; H04L 9/32

(52) U.S. Cl. CPC G06Q 20/407; G06Q 20/223; H04L 9/3213; H04L 2209/56

(57) ABSTRACT

A method for enabling refund of a non-fungible token (NFT) includes: receiving a transaction message for a payment transaction; processing the payment transaction using the transaction message, where processing includes identification of a transaction identifier for the payment transaction; transmitting the transaction identifier to a first device; receiving a notification message including the transaction identifier and a token identifier, where the token identifier is associated with the NFT; receiving a refund request message from a second device, where the refund request message includes the transaction identifier and/or the token identifier; processing a refund transaction for the payment transaction; and submitting the transaction identifier as input into a smart contract stored in a blockchain associated with the NFT for reversal of ownership of the NFT.

### FIELD

The present disclosure relates to enabling the automatic refund of a non-fungible token (NFT), specifically enforcing the refund of an NFT following the refund of the payment transaction for initial transfer of ownership of the NFT.

### BACKGROUND

Blockchain and other distributed ledgers have been used for a wide variety of applications since their inception. Most commonly, blockchains are used in the management and transfer of digital currency. Some of the advantages of using a blockchain that are responsible for the rise in popularity of digital currencies is that a blockchain is largely immutable, transactions have a high level of anonymity, and blockchain networks are decentralized. Because of these advantages, blockchains have been used in many applications beyond digital currency, such as for voting, data storage, supply chain management, and more.

Recently, non-fungible tokens (NFTs) have become a popular use of blockchain technology. An NFT is a digital asset whose ownership is tracked using a blockchain. The digital asset can be any type of asset, such as an text, data, image, song, or video, where the original creator of the asset creates an NFT for the asset that is stored on a blockchain, such as Ethereum ®. The creator is then free to transfer the NFT to any other interested party, where the transfer of ownership is registered via a transaction on the blockchain from the creator to the transferee. Often, the recipient will purchase the NFT via a traditional payment transaction using a fiat currency.

However, reliance on blockchain technology for the registration, also referred to as “minting,” of NFTs and the transfer thereof is not without its downsides. One downside in particular is that blockchain transactions, unlike traditional payment transactions, are not reversible due to the decentralized nature of the blockchain. In a traditional payment transaction that is processed via a payment network, such as a credit card transaction, if the buyer feels defrauded or does not receive a purchased product, the payment network can force a refund of the payment transaction, ensuring that the buyer receives their payment back. However, because there is no centralized management in a blockchain, the ability to reverse or refund a transaction does not exist. This can place both buyer and seller in a vulnerable position, where either party is forced to trust that the other will perform their requisite transaction (returned transfer of the NFT to the seller or a payment transaction for payment back to the buyer).

Thus, there is a need for a technical improvement to existing technologies to enable a trusted and secure refund of the purchase or transfer of an NFT.

### SUMMARY

The present disclosure provides a description of systems and methods for enabling refund of a non-fungible token (NFT) involving use of a smart contract. When an NFT is purchased, the payment transaction for the payment made for the purchase is processed and an identifier associated therewith is generated. The identifier of the payment transaction is stored in a smart contract that is added to a blockchain along with an identifier for the NFT as well as the blockchain addresses for the buyer and seller. If either party wants to refund the transaction, a refund request is submitted to a processing server that includes the transaction identifier. The processing server initiates a refund of the payment transaction and then submits the transaction identifier as input to the smart contract. The smart contract executes a new transaction on the blockchain to transfer ownership from the buyer back to the seller. The result is that both the initial payment transaction and the transfer of the NFT are reversed, returning both parties to their original position. By using a smart contract in conjunction with a processing server, the purchase of an NFT can be reversed with minimal action by either participant and with a guarantee that the reversal will occur without the opportunity for the other participant to engage in any fraudulent action. The result is a significant advantage over existing systems used in the transfer of ownership of NFTs.

A method for enabling refund of a non-fungible token (NFT) includes: receiving, by a receiver of a processing server, a transaction message for a payment transaction; processing, by a processor of the processing server, the payment transaction using at least the transaction message, where processing includes identification of a transaction identifier for the payment transaction; transmitting, by a transmitter of the processing server, the transaction identifier to a first computing device; receiving, by the receiver of the processing server, a notification message including at least the transaction identifier and a token identifier, where the token identifier is associated with the NFT; receiving, by the receiver of the processing server, a refund request message from a second computing device, where the refund request message includes at least one of: the transaction identifier and the token identifier; processing, by the processor of the processing server, a refund transaction for the payment transaction; and submitting, by the transmitter of the processing server, at least the transaction identifier as input into a smart contract stored in a blockchain associated with the NFT.

A system for enabling refund of a non-fungible token (NFT) includes: a first computing device; a second computing device; a blockchain associated with the NFT; and a processing server, the processing server including a receiver receiving a transaction message for a payment transaction, a processor processing the payment transaction using at least the transaction message, where processing includes identification of a transaction identifier for the payment transaction, and a transmitter transmitting, the transaction identifier to the first computing device, wherein the receiver of the processing server further receives a notification message including at least the transaction identifier and a token identifier, where the token identifier is associated with the NFT, and a refund request message from the second computing device, where the refund request message includes at least one of: the transaction identifier and the token identifier, the processor of the processing server further processes a refund transaction for the payment transaction, and the transmitter of the processing server further submits at least the transaction identifier as input into a smart contract stored in the blockchain associated with the NFT.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for enabling refund of an NFT in accordance with exemplary embodiments.

FIG. 2 is a block diagram illustrating a processing server for enabling refund of an NFT in the system of FIG. 1 in accordance with exemplary embodiments.

FIGS. 3A and 3B are a flow diagram illustrating a process for the transfer of ownership of an NFT following a payment transaction in the system of FIG. 1 in accordance with exemplary embodiments.

FIG. 4 is a flow diagram illustrating a process for enforcing a refund of an NFT and associated payment transaction in the system of FIG. 1 in accordance with exemplary embodiments.

FIG. 5 is a flow chart illustrating an exemplary method for enabling refund of an NFT in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Enabling Refund of a Non-Fungible Token

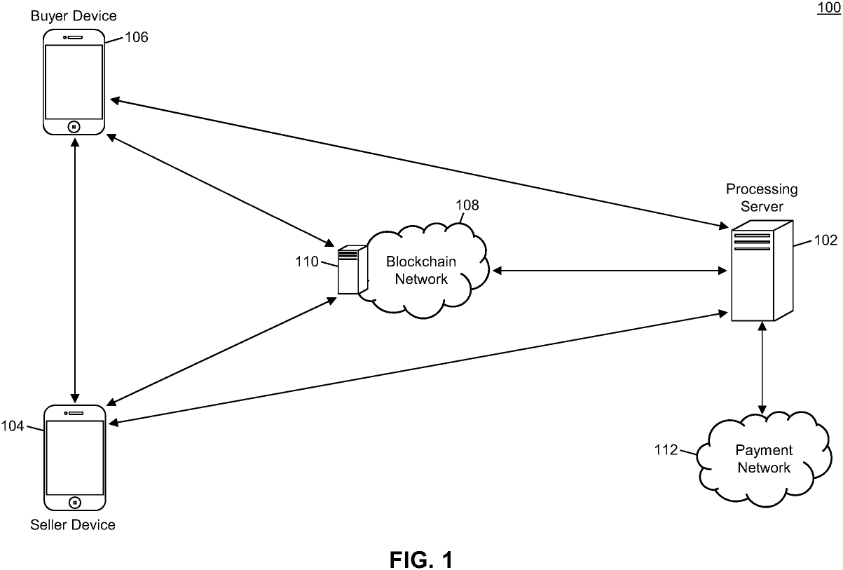

FIG. 1 illustrates a system 100 that provides for the automatic refunding and reversal of a transaction for the transfer of ownership of a non-fungible token (NFT). The system 100 can include a processing server 102. The processing server 102, discussed in more detail below, can be configured to facilitate the automatic refunding and reversal of transfer of ownership of an NFT via the use of a smart contract. In the system 100, a party may have ownership of an NFT via a seller device 104, such as the creator of the NFT or another party that has gained ownership of the NFT via any suitable method. A party associated with a buyer device 106 may be interested in purchasing the NFT from the party associated with the seller device 104. As discussed herein, the parties associated with the seller device 104 and buyer device 106 may be referred to via their associated devices. The seller device 104 and buyer device 106 can be any type of computing device suitable for performing the functions discussed herein, such as a cellular phone, smart phone, smart watch, smart television, desktop computer, laptop computer, notebook computer, tablet computer, wearable computing device, etc.

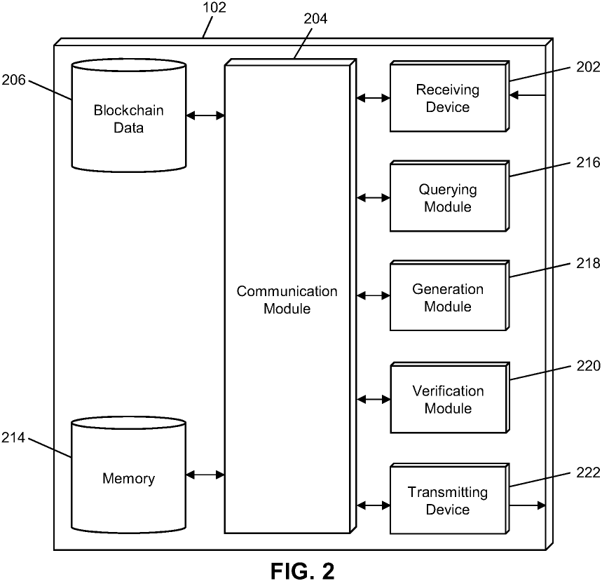

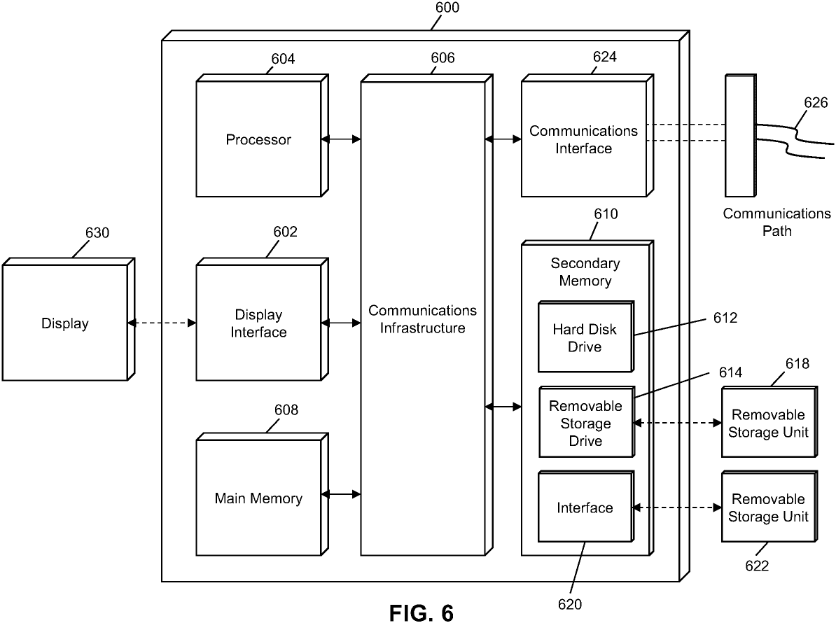

In the system 100, ownership of the NFT can be stored in a blockchain. The blockchain may be managed by a blockchain network 108 included in the system 100. The blockchain network 108 can be comprised of a plurality of blockchain nodes 110. Each blockchain node 110 can be a computing system, such as illustrated in FIGS. 2 or 6, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block’s block reference value to be newly generated, further requiring the generation of a new block reference value in every subsequent block. This would have to be performed and updated in every single blockchain node 110 in the blockchain network 108 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 108 using the public key of the cryptographic key pair. In some cases, the term “blockchain wallet” can refer specifically to the private key. In other cases, the term “blockchain wallet” can refer to a computing device (e.g., seller device 104, buyer device 106, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a buyer device 106) that is generated using the sender’s private key, a blockchain address of the recipient of currency (e.g., a seller device 104) generated using the recipient’s public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender’s public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender’s public key, for use by an entity in validating the transaction. For the traditional processing of a blockchain transaction, such data can be provided to a blockchain node 110 in the blockchain network 108, either by the sender or the recipient. The node can verify the digital signature using the public key in the cryptographic key pair of the sender’s wallet and also verify the sender’s access to the funds (e.g., that the unspent transactions have not yet been spent and were sent to address associated with the sender’s wallet), a process known as “confirmation” of a transaction, and then include the blockchain transaction in a new block. The new block can be validated by other nodes in the blockchain network 108 before being added to the blockchain and distributed to all of the blockchain nodes 110 in the blockchain network 108, respectively, in traditional blockchain implementations. In cases where a blockchain data value cannot be related to a blockchain transaction, but instead the storage of other types of data, blockchain data values can still include or otherwise involve the validation of a digital signature.

In the system 100, records regarding ownership of an NFT can be stored in blockchain data entries in the blockchain associated with the blockchain network 108. A data value that is representative of the NFT is stored in a blockchain data entry where a transfer of ownership is recorded in the blockchain via the addition of a new blockchain data entry in a new block that includes the data value for the NFT as well as a recipient address of a blockchain wallet of the recipient. The recipient is then free to make a further transfer of ownership of the NFT via proof of their ownership, which can be made via the generation of a digital signature of the cryptographic key pair of their blockchain wallet, where the corresponding public key was used to generate the recipient address of the NFT.

In the system 100, the buyer device 106 can agree to purchase an NFT owned by the seller device 104 for an amount of currency. In some embodiments, the buyer device 106 may purchase the NFT using a traditional payment transaction, such as processed by a payment network 112 using a credit card, debit card, or other suitable type of payment instrument. In other embodiments, the buyer device 106 can purchase the NFT using a digital currency transferred via a blockchain, which can be the same blockchain used to record transfers of ownership of the NFT or a separate blockchain, which can also be managed by the blockchain network 108 or by an additional blockchain network 108 in the system 100.

In instances where a traditional payment transaction is used, the buyer device 106 can submit a payment using any suitable method. For instance, the processing server 102 can provide a service where the buyer device 106 submits payment details (e.g., transaction amount, account details for the transaction account from which payment is to be made, account details for the recipient transaction account, such as provided by the seller device 104, etc.), the buyer device 106 can use a suitable website or application program, etc. An authorization request for the payment transaction can be electronically transmitted to a payment network 112 using payment rails associated therewith. An authorization request can be a specially formatted transaction message that is formatted according to one or more standards governing the exchange of financial transaction messages, such as the International Organization of Standardization’s ISO 8583 or ISO 20022 standards. The authorization request can include the payment details for the payment transaction stored in data elements included therein, such as the transaction amount, account details for the payer transaction account, and account details for the payee transaction account. The payment network 112 can process the payment transaction using traditional systems and methods.

As part of the processing of the payment transaction, a transaction identifier can be generated (e.g., by the payment network 112, the processing server 102, or other entity or system involved in the processing of the payment transaction). The transaction identifier can be provided to the buyer device 106 in a confirmation message confirming successful processing of the payment transaction. In cases where the processing server 102 is involved in the processing of the payment transaction, the processing server 102 can receive the transaction identifier as part of its involvement in the processing of the payment transaction. In some such cases, the processing server 102 can provide the confirmation message to the buyer device 106 using a suitable communication network and method. In other cases, the buyer device 106 and/or seller device 104 can provide the transaction identifier to the processing server 102 after receipt of the confirmation message.

In embodiments where a digital currency is used for payment for the purchase of the NFT, the buyer device 106 can electronically submit transaction details for a blockchain transaction, which can be directly submitted to a blockchain node 110, be submitted to the processing server 102 for forwarding to a blockchain node 110 on behalf of the buyer device 106, or to the processing server 102 for processing in cases where the processing server 102 can be a blockchain node 110 in the blockchain network 108. A new blockchain transaction can then be processed and added to the blockchain for transfer of a specified amount of digital currency from the blockchain wallet of the buyer device 106 to the blockchain wallet of the seller device 104 using the methods discussed above.

In some embodiments, the seller device 104 can initiate processing of the traditional or blockchain payment transaction using transaction details provided by the buyer device 106.

The seller device 104 can submit a request for transfer of ownership of the NFT being purchased to the blockchain network 108, which can be directly submitted to a blockchain node 110, be submitted to the processing server 102 for forwarding to a blockchain node 110 on behalf of the seller device 104, or to the processing server 102 for processing in cases where the processing server 102 can be a blockchain node 110 in the blockchain network 108. The request can include a digital signature generated by the private key of the cryptographic key pair that comprises the seller device’s blockchain wallet, which can corresponding to the public key used to generate the address that currently has ownership of the NFT as registered in the blockchain. Verification of the seller device’s ownership of the NFT can be performed via validating the digital signature using the same public key that was used to generate the address that currently has ownership of the NFT. The request can also include a destination address to which the ownership of the NFT is to be transferred, which can be generated via the public key of the cryptographic key pair that comprises the buyer device’s blockchain wallet, which the buyer device 106 can have transmitted to the seller device 104 prior to the transfer of ownership. The blockchain node 110 can verify and validate the necessary data, then generate a new blockchain data entry that includes the transfer of ownership that is included in a new block that is generated, validated, and added to the blockchain using traditional methods and systems. A transaction identifier can be generated for the blockchain transaction that is then returned to the buyer device 106 in a confirmation message or can be identified by the buyer device 106 in the blockchain data entry for the blockchain transaction stored in the blockchain.

In some embodiments, the payment transaction can be processed prior to the transfer of ownership of the NFT on the blockchain. In other embodiments, the transfer of ownership of the NFT can occur prior to processing of the payment transaction. In still other embodiments, the payment transaction and transfer of ownership of the NFT can be performed concurrently.

In the system 100, a smart contract can be generated and stored in the blockchain associated with the blockchain network 108 that can be used to facilitate the automatic reversal of the transfer of ownership of the NFT from the buyer device 106 back to the seller device 104. In some embodiments, the smart contract can be generated following the processing of the payment transaction and/or transfer of ownership of the NFT as discussed above. In other embodiments, the smart contract can be generated following processing of the payment transaction and prior to transfer of ownership of the NFT. In such embodiments, the smart contract can be configured to execute a function to process the transfer of ownership of the NFT once the payment transaction has been processed. In such an embodiment, the function can be executed by the smart contract with the transaction identifier for the processed payment transaction as input, where execution of the smart contract can result in the generation of the blockchain transaction for the transfer of ownership of the NFT from the seller device 104 to the buyer device 106 as discussed above.

The smart contract can be configured to store at least a token identifier for the NFT, the blockchain address associated with the seller device 104 that initially had ownership of the NFT, and the blockchain address associated with the buyer device 106 to where ownership of the NFT was transferred. The token identifier can be a value associated with the NFT or can be the data value that is the digital asset itself (e.g., a hash of the image, video, etc.). In cases where the smart contract executes to process the transfer of ownership, the smart contract can store the transaction identifier received as input. In cases where the smart contract is generated after the transfer of ownership of the NFT, the transaction identifier can be included in the smart contract as part of the process of the generation thereof.

In the system 100, the seller device 104 or buyer device 106 can be interested in having the payment transaction and transfer of ownership of the NFT reversed. In an example, the buyer may have made an incorrect payment amount and the seller may be interested in having the transaction reversed if the appropriate payment is not made. In another example, the NFT transferred to the buyer can be different than the asset originally discussed by the parties. In yet another example, the seller can provide the buyer with a return policy that the buyer wishes to exercise, where the system 100 is utilized to provide for a faster, more secure, and easier return process.

When a reversal is desired, the seller device 104 or buyer device 106 can electronically submit a refund request to the processing server 102 using a suitable communication network and method, such as using a webpage, application program, application programming interface (API), etc. In some cases, the processing server 102 can require confirmation from both the buyer device 106 and seller device 104 prior to processing a refund request. In such cases, the seller device 104 and/or buyer device 106 can be authenticated prior to processing, such as using a digital signature generated by the device’s private key and validated using the corresponding public key.

The refund request can include the transaction identifier for the payment transaction that is to be refunded. The processing server 102 can identify the payment transaction using the transaction identifier. The processing server 102 can then initiate the processing of a refund transaction for the payment transaction. In some instances, a dispute resolution process can occur when a refund request is received by the processing server 102. For instance, the processing server 102 can, directly or via a third party service (e.g., offered by the payment network 112), execute a dispute resolution process to determine if the refund should be approved, such as by gathering evidence from the seller device 104 and buyer device 106 based on a requested reason for the refund. In an example, the seller device 104 can request the refund stating that insufficient payment was made, and present past communications from the buyer device 106 agreeing on a different price as evidence. Likewise, it the NFT is defective (e.g., corrupted, incorrect, misidentified, etc.), the buyer can provide evidence of such. If the dispute resolution process finds that the refund request should be denied, a notification message indicating accordingly can be transmitted to the submitter of the refund request. If the dispute resolution approves the refund, then the processing server 102 can proceed by refunding the initial payment transaction. In cases where a traditional payment transaction was used, a transaction message can be submitted to the payment network 112 using payment rails associated therewith that includes the transaction identifier, which can result in payment for the original transaction amount being paid back from the original recipient transaction account to the original payer transaction account. In some cases, the refund transaction can be processed via an authorization request for a new payment transaction for the same transaction amount where the payment details for the transaction accounts are swapped such that the payment initially made to the seller from the buyer is made back to the buyer from the seller.

In cases where a blockchain transaction was used, a new blockchain transaction can be generated that is submitted to a blockchain node 110 for payment of the original digital currency amount from the blockchain wallet of the seller device 104 back to the blockchain wallet of the buyer device 106. In some embodiments, the seller device 104 can generate a digital signature over the unspent transaction output for the initial blockchain transaction that is provided to the processing server 102 or in the smart contract, where the digital signature is used in the submission of the new blockchain transaction to ensure that the blockchain transaction is successfully validated and processed. In cases where the digital signature is included in the smart contract, refunding of the blockchain transaction can be performed via the execution of an appropriate function in the smart contract using the transaction identifier as input, where the smart contract can generate the blockchain transaction and submit the transaction to a blockchain node 110.

In addition to the processing of the refund, the processing server 102 can submit the transaction identifier as input into the smart contract. In some cases, the smart contract can be configured to initiate a reversal of the transfer of ownership of the NFT when a transaction identifier is submitted, which can occur only after other functions related to receipt of the transaction identifier as input have been performed (e.g., the initial transfer of ownership of the NFT). In other cases, the smart contract can include a function for the reversal of the transfer of ownership of the NFT (e.g., a refund()function), where the transaction identifier can be supplied as input for the function. The smart contract can execution the function, which can identify the token identifier associated with the NFT, and then generate a new blockchain transaction for transfer of ownership from the buyer device 106 back to the seller device 104. In cases where a digital signature is required for the transfer, the buyer device 106 can have supplied the digital signature generated using its private key as part of the initial process (e.g., when submitting the payment transaction, submitting the transaction identifier for the payment transaction, provided to the seller device 104 for submission thereby, etc.). The new blockchain transaction is then automatically submitted to a blockchain node 110 for verification and addition to the blockchain. Once added to the blockchain, the seller device 104 will have been returned ownership of the NFT.

In some embodiments, the blockchain network 108 can be configured to enable multiple entities to initiate transfer of ownership of an NFT. For instance, the entity that has ownership of an NFT via control of the address to which the NFT was transferred (e.g., demonstrated using a digital signature generated using the private key that corresponds to the public key used to generate the address) can also specify another entity with a blockchain address (e.g., similarly authenticated using cryptographic keys) or other data used for authentication. In such cases, the processing server 102 can be specified as the other entity that is allowed to transfer ownership of the NFT. The processing server 102 can then include its own digital signature or other authentication data, which can be supplied as input to the smart contract along with the transaction identifier to accomplish the reversal of the transfer of ownership of the NFT.

The methods and systems discussed herein enable for automated reversal of the transfer of ownership of the NFT. By using a processing server as well as a smart contract and the appropriate input, a payment transaction, both traditional or using digital currency, can be automatically refunded and the ownership of the NFT automatically reversed back to the original owner with nothing more than a single submission of the transaction identifier by the seller device 104 or buyer device 106. The result is a fast and secure process for refund and reversal with minimal interaction required by the involved parties that removes the ability for fraud to be perpetuated by either party. As a result, entities can have more flexibility than ever when conducting transactions that involve the transfer of ownership of NFTs.

### Processing Server

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 600 illustrated in FIG. 6 and discussed in more detail below can be a suitable configuration of the processing server 102. In some cases, additional components of the system 100, such as the seller device 104, buyer device 106, blockchain node 110, can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from seller device 104, buyer device 106, blockchain node 110, payment network 112, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by seller devices 104 and/or buyer devices 106 that can be superimposed or otherwise encoded with payment transaction data, transaction identifiers, token identifiers, smart contract data, refund requests, etc. The receiving device 202 can also be configured to receive data signals electronically transmitted by blockchain nodes 110 in the blockchain network 108, which can be superimposed or otherwise encoded with blockchain data, transaction identifiers, notification messages, etc. The receiving device 202 can be further configured to receive data signals electronically transmitted by payment networks 112, such as via payment rails associated therewith, that can be superimposed or otherwise encoded with transaction messages, notification messages, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include blockchain data 206, which may be stored in a memory 214 of the processing server 102 or stored in a separate area within the processing server 102 or accessible thereby. The blockchain data 206 may include a blockchain, which may be comprised of a plurality of blocks and be associated with the blockchain network 108. In some cases, the blockchain data 206 may further include any other data associated with the blockchain and management and performance thereof, such as block generation algorithms, digital signature generation and confirmation algorithms, communication data for blockchain nodes 110, smart contracts, cryptographic key pairs, public keys, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, encryption algorithms, encryption keys, data formatting rules, signature generation algorithms, standards, public databases, private databases, payment network processing rules, transaction messages standards data, etc.

The processing server 102 can include a querying module 216. The querying module 216 can be configured to execute queries on databases to identify information. The querying module 216 can receive one or more data values or query strings and can execute a query string based thereon on an indicated database, such as memory 214 of the processing server 102 to identify information stored therein. The querying module 216 can then output the identified information to an appropriate engine or module of the processing server 102 as necessary. The querying module 216 can, for example, execute a query on the memory 214 to identify a private key for use in generating a digital signature for submission to a smart contract as input for the reversal of the transfer of ownership of an NFT.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate transaction messages, blockchain transactions, blockchain data entries, digital signatures, blocks, response messages, notification messages, etc.

The processing server 102 can also include a verification module 220. The verification module 220 can be configured to perform verifications for the processing server 102 as part of the functions discussed herein. The verification module 220 can receive instructions as input, which can also include data to be used in performing a verification, can perform a verification as requested, and can output a result of the verification to another module or engine of the processing server 102. The verification module 220 can, for example, be configured to verify digital signatures using suitable signature generation algorithms and keys, verify hash values by hashing supplied data using a suitable one-way hashing algorithm, verify NFT ownership based on blockchain addresses and cryptographic key data, verify payment transactions, etc.

The processing server 102 can also include a transmitting device 222. The transmitting device 222 can be configured to transmit data over one or more networks via one or more network protocols. In some instances, the transmitting device 222 can be configured to transmit data to seller devices 104, buyer devices 106, blockchain nodes 110, payment networks 112, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to seller devices 104 and/or buyer devices 104 that can be superimposed or otherwise encoded with notification messages for payment transactions, requests for digital signatures, notification messages regarding blockchain transactions, requests for smart contract data, etc. The transmitting device 222 can also be configured to electronically transmit data signals to blockchain nodes 110, which can be superimposed or otherwise encoded with blockchain transactions, blockchain data entries, blocks, response messages, smart contract data, input for smart contracts, etc. The transmitting device 222 can be further configured to electronically transmit data signals to payment networks 112, such as via payment rails associated therewith, that can be superimposed or otherwise encoded with transaction messages, authorization requests, refund messages, etc.

### Process for Transferring Ownership of a Non-Fungible Token

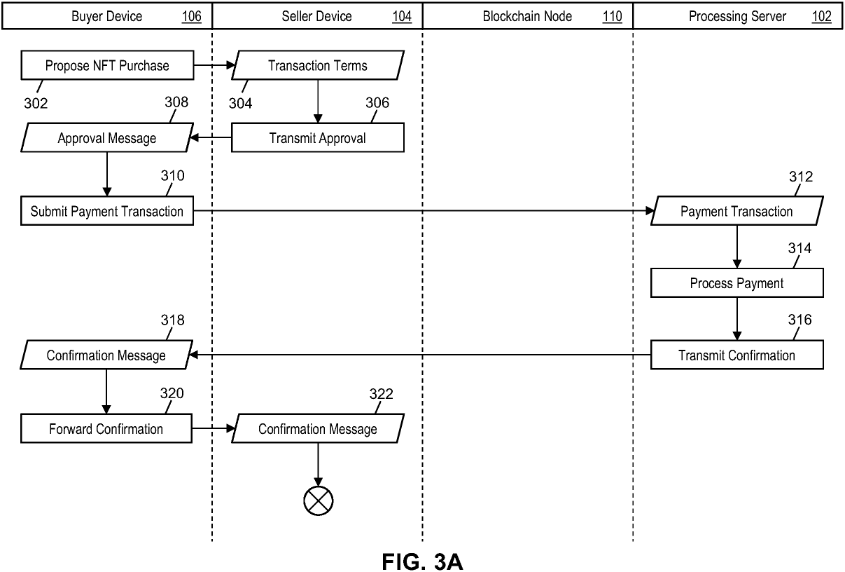

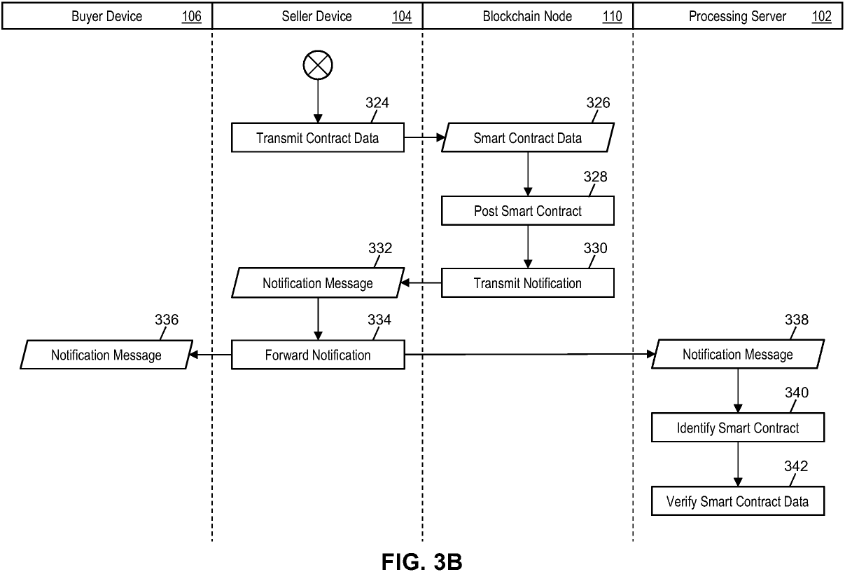

FIGS. 3A and 3B illustrates a process for transferring ownership of a non-fungible token (NFT) in the system 100 from a seller device 104 to a buyer device 106 in exchange for payment via a traditional payment transaction that is capable of automatic refund and reversal.

In step 302, the buyer device 106 can electronically transmit a message to the seller device 104 using a suitable communication network and method that proposes a purchase of an NFT owned by the seller device 104. In step 304, the seller device 104 can receive the message, which can include transaction terms, such as a transaction amount, currency type, and the token identifier for the NFT that is to be purchased. In some cases, the terms can also include a blockchain address for the buyer device 106 for receipt of the NFT. The terms can be presented to a user of the seller device 104 who can decide to proceed with the transaction and provide input approving the transaction. In step 306, the seller device 104 can transmit its approval of the proposed transaction to the buyer device 106 using a suitable communication network and method. The approval can include at least account details for a transaction account to which the payment is to be made, such as an account number, username, e-mail address, telephone number, or other data that can be dependent on the service and/or payment instrument used for the payment transaction. In step 308, the buyer device 106 can receive the approval message and included account details.

In step 310, the buyer device 106 can electronically transmit a message for a desired payment transaction to the processing server 102 using a suitable communication network and method. The message can include at least the account details for the seller’s transaction account, account details for a transaction account of the buyer used to fund the payment transaction, and the transaction amount. In some cases, the message can also include the token identifier for the NFT. In step 312, the receiving device 202 of the processing server 102 can receive the message for the payment transaction. In step 314, the processing server 102 can process the payment transaction using a suitable method. In some cases, the processing server 102 can generate (e.g., via the generation module 218) an authorization request for the payment transaction that submitted to the payment network 112 using associated payment rails. In other cases, the processing server 102 can submit the payment details for the transaction accounts and the transaction account to another payment service to facilitate the transfer of funds to accomplish the payment transaction. As part of the processing of the payment transaction, in step 314, the processing server 102 can identify a transaction identifier for the payment transaction, which can be a value (e.g., a number) that is unique to that payment transaction.

In step 316, the transmitting device 222 of the processing server 102 can electronically transmit a confirmation message for the successful payment transaction to the buyer device 106. The confirmation message can include at least the transaction identifier, and can also include any additional transaction details, such as the transaction amount, a portion of the account details for the seller’s transaction account, etc. In step 318, the buyer device 106 can receive the confirmation message. In step 320, the buyer device 106 can forward the confirmation message to the seller device 104 for receipt thereby, in step 322. The confirmation message can be presented to a user of the seller device 104 to notify the seller that payment for the proposed amount was successfully made to the seller’s transaction account. In cases where the buyer device 106 did not previously provide a destination address for the NFT to the seller device 104, the buyer device 106 can append the destination address to the confirmation message.

In step 324, the seller device 104 can electronically transmit data for a smart contract to a blockchain node 110 in the blockchain network 108 using a suitable communication network and method. The data can include at least the transaction identifier for the processed payment transaction, the token identifier associated with the NFT, the seller’s blockchain address that has ownership of the NFT (e.g., and a digital signature generated by the seller’s private key, if applicable), and the destination address for the NFT generated by the buyer device 106. In step 326, the blockchain node 110 can receive the smart contract data. In step 328, the blockchain node 110 can validate the seller’s ability to transfer ownership of the specified NFT, generate the smart contract using the provided data, generate a new block that includes the smart contract, and have the new block confirmed and added, i.e., posted to the blockchain. In step 330, the blockchain node 110 can transmit a notification message to the seller device 104 that indicates that the smart contract was successfully added to the blockchain.

In step 332, the seller device 104 can receive the notification message from the blockchain node 110. In step 334, the seller device 104 can forward the notification message to the buyer device 106 and the processing server 102 to inform the parties that the transfer of ownership of the NFT was successfully performed. In step 336, the buyer device 106 can receive the notification message, which can be displayed to a user thereof to inform the user that they now have ownership of the NFT. In step 338, the receiving device 202 of the processing server 102 can receive the notification message from the seller device 104. In step 340, the processing server 102 can identify the smart contract as stored in the blockchain, such as by using the transaction identifier. In step 342, the verification module 220 of the processing server 102 can verify the data included in the smart contract to ensure its accuracy, such as by checking that the token identifier corresponds to one submitted with the payment transaction data and checking the accuracy of the transaction identifier.

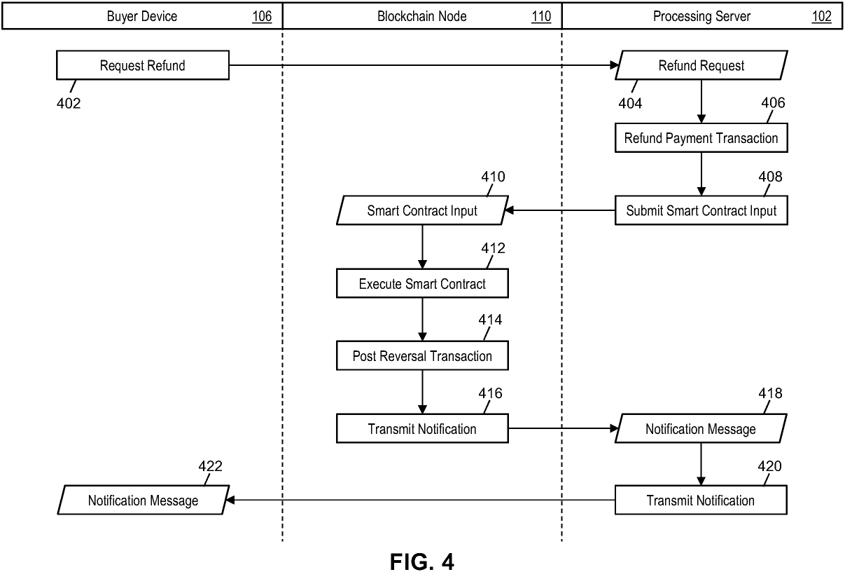

The result of the process illustrated in FIGS. 3A and 3B is the transfer of the negotiated amount of fiat currency from the buyer to the seller and the transfer of the agreed-upon NFT from the seller to the buyer, where the corresponding data is registered in a smart contract that is stored on the blockchain, which can be used to facilitate reversal of the transfer of ownership of the NFT if desired, as discussed in more detail below in the process illustrated in FIG. 4.

### Process for Refund and Reversal of Ownership Transfer of a Non-Fungible Token

FIG. 4 illustrates a process for the automatic refunding of a traditional payment transaction and reversal of the transfer of ownership of an NFT in the system 100, such as transferred using the process illustrated in FIGS. 3A and 3B, as discussed above.

In step 402, the buyer device 106 (e.g., or seller device 104, as desired) can electronically transmit a request for the refund of a payment transaction and reversal of transfer of ownership of an NFT to the processing server 102 using a suitable communication network and method. The refund request can include at least the transaction identifier associated with the payment transaction for the transfer of a specified amount of fiat currency from the buyer to the seller. In step 404, the receiving device 202 of the processing server 102 can receive the refund request. In step 406, the processing server 102 can initiate the processing of a refund of the payment transaction. In cases where the processing server 102 initiated the payment transaction directly, the processing server 102 can generate (e.g., via the generation module 218) an appropriate transaction message that is submitted to the payment network 112 using associated payment rails that includes the transaction identifier. In other cases, the processing server 102 can submit the transaction identifier to the payment service to facilitate the transfer of back to the buyer’s transaction account from the seller’s transaction account using a suitable method. In some embodiments, the processing server 102 can perform a dispute resolution process to determine if the refund should be approved, where step 406 can be initiated only following the approval of the refund request as a result of the dispute resolution process.

In step 408, the transmitting device 222 of the processing server 102 can submit the transaction identifier as input into the smart contract associated with the transfer of ownership of the NFT, which can be identified using the transaction identifier that is stored in the blockchain associated with the blockchain network 108. In step 410, a blockchain node 110 in the blockchain network 108 can receive the transaction identifier, which, in step 412, can be submitted as input into the smart contract for execution thereby. As an alternative, in step 412, the smart contract can initiate the above mention dispute resolution and await its result before the posting a reversal transaction. Execution of the smart contract can include the generation of a new blockchain transaction for transfer of ownership of an NFT, identified via the token identifier stored in the smart contract associated with the transaction identifier that is submitted to the blockchain node 110. In step 414, the blockchain node 110 can generate a new block that includes the new blockchain transaction, and have the new block confirmed and added to the blockchain. In step 416, the blockchain node 110 can transmit a notification message to the processing server 102 that indicates that the new transfer of ownership back to the seller device 104 was successfully added to the blockchain.

In step 418, the receiving device 202 of the processing server 102 can receive the notification message from the blockchain node 110. In step 420, the generation module 218 of the processing server 102 can generate a new notification message that indicates that the payment transaction was refunded and ownership of the NFT transferred back to the seller device 104, which can be transmitted by the transmitting device 222 of the processing server 102 to the buyer device 106. In step 422, the buyer device 106 can receive the notification message, which can be presented to the user thereof and/or forwarded on to the seller device 104 to inform the seller of the refund and reversal as well.

The result of the process illustrated in FIG. 4 and discussed above is the automated refund of the fiat currency payment transaction back to the buyer and automated reversal of the transfer of ownership of the NFT back to the seller in a manner that is guaranteed without the opportunity for fraud, which can be initiated via a single message submitted by the buyer device 106 or seller device 104 and accomplished via use of the processing server 102 and a specially configured smart contract.

### Exemplary Method for Enabling Refund of a Non-Fungible Token

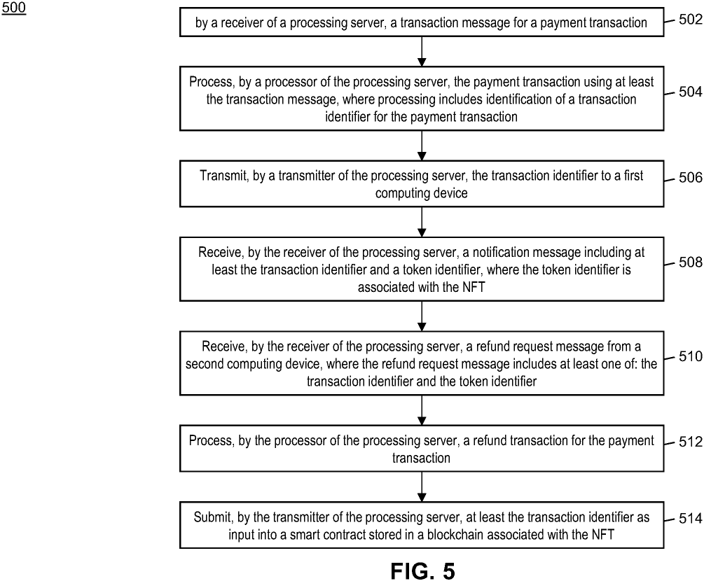

FIG. 5 illustrates a method 500 for the automated refunding of a non-fungible token (NFT) to revert ownership and the refund of a corresponding payment transaction via use of a processing server and smart contract.

In step 502, a transaction message for a payment transaction can be received by a receiver (e.g., receiving device 202) of a processing server (e.g., processing server 102. In step 504, the payment transaction can be processed by a processor of the processing server using at least the transaction message, where processing includes identification of a transaction identifier for the payment transaction. In step 506, the transaction identifier can be transmitted by a transmitter (e.g., transmitting device 222) of the processing server to a first computing device (e.g., seller device 104, buyer device 106, blockchain node 110, etc.).

In step 508, a notification message can be received by the receiver of the processing server that includes at least the transaction identifier and a token identifier, where the token identifier is associated with the NFT. In step 510, a refund request message can be received by the receiver of the processing server from a second computing device (e.g., seller device 104, buyer device 106, etc.) where the refund request message includes at least one of: the transaction identifier and the token identifier. In step 512, a refund transaction for the payment transaction can be processed by the processor of the processing server. In step 514, at least the transaction identifier can be submitted by the transmitter of the processing server as input into a smart contract stored in a blockchain associated with the NFT.

In one embodiment, the transaction message can be an authorization request formatted according to one or more standards, and the payment transaction can be for payment from a first transaction account to a second transaction account using a fiat currency. In some embodiments, the transaction message can be a data message for a blockchain transaction, and the payment transaction can be processed using one or more blockchain nodes (e.g., blockchain nodes 110) in a blockchain network (e.g., blockchain network 108). In a further embodiment, the blockchain transaction can be added to a second blockchain different from the blockchain associated with the NFT.

In one embodiment, the smart contract can execute using the transaction identifier as input to reverse a prior transfer of ownership of the NFT on the blockchain associated with the NFT. In some embodiments, the smart contract can include at least the transaction identifier, token identifier, buyer address, and seller address. In one embodiment, the method 500 can further include: verifying, by the processor (e.g., verification module 220) of the processing server, transfer of ownership of the NFT after receiving the notification message, wherein verifying transfer of ownership of the NFT includes identifying a block in the blockchain associated with the NFT that includes a blockchain data entry including at least the token identifier and the transaction identifier. In some embodiments, the transaction identifier can be submitted into the smart contract as input in a function call included in the smart contract.

### Computer System Architecture

FIG. 6 illustrates a computer system 600 in which embodiments of the present disclosure, or portions thereof, can be implemented as computer-readable code. For example, the processing server 102 of FIGS. 1 and 2 can be implemented in the computer system 600 using hardware, non-transitory computer readable media having instructions stored thereon, or a combination thereof and can be implemented in one or more computer systems or other processing systems. Hardware can embody modules and components used to implement the methods of FIGS. 3A, 3B, 4, and 5.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 604 can be a special purpose or a general-purpose processor device specifically configured to perform the functions discussed herein. The processor device 604 can be connected to a communications infrastructure 606, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 can also include a main memory 608 (e.g., random access memory, read-only memory, etc.), and can also include a secondary memory 610. The secondary memory 610 can include the hard disk drive 612 and a removable storage drive 614, such as a floppy disk drive, a magnetic tape drive, an optical disk drive, a flash memory, etc.

The removable storage drive 614 can read from and/or write to the removable storage unit 618 in a well-known manner. The removable storage unit 618 can include a removable storage media that can be read by and written to by the removable storage drive 614. For example, if the removable storage drive 614 is a floppy disk drive or universal serial bus port, the removable storage unit 618 can be a floppy disk or portable flash drive, respectively. In one embodiment, the removable storage unit 618 can be non-transitory computer readable recording media.

In some embodiments, the secondary memory 610 can include alternative means for allowing computer programs or other instructions to be loaded into the computer system 600, for example, the removable storage unit 622 and an interface 620. Examples of such means can include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 600 can also include a communications interface 624. The communications interface 624 can be configured to allow software and data to be transferred between the computer system 600 and external devices. Exemplary communications interfaces 624 can include a modem, a network interface (e.g., an Ethernet card), a communications port, a PCMCIA slot and card, etc. Software and data transferred via the communications interface 624 can be in the form of signals, which can be electronic, electromagnetic, optical, or other signals as will be apparent to persons having skill in the relevant art. The signals can travel via a communications path 626, which can be configured to carry the signals and can be implemented using wire, cable, fiber optics, a phone line, a cellular phone link, a radio frequency link, etc.

The computer system 600 can further include a display interface 602. The display interface 602 can be configured to allow data to be transferred between the computer system 600 and external display 630. Exemplary display interfaces 602 can include high-definition multimedia interface (HDMI), digital visual interface (DVI), video graphics array (VGA), etc. The display 630 can be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 608 and secondary memory 610, which can be memory semiconductors (e.g., DRAMs, etc.). These computer program products can be means for providing software to the computer system 600. Computer programs (e.g., computer control logic) can be stored in the main memory 608 and/or the secondary memory 610. Computer programs can also be received via the communications interface 624. Such computer programs, when executed, can enable computer system 600 to implement the present methods as discussed herein. In particular, the computer programs, when executed, can enable processor device 604 to implement the methods illustrated by FIGS. 3A, 3B, 4, and 5, as discussed herein. Accordingly, such computer programs can represent controllers of the computer system 600. Where the present disclosure is implemented using software, the software can be stored in a computer program product and loaded into the computer system 600 using the removable storage drive 614, interface 620, and hard disk drive 612, or communications interface 624.

The processor device 604 can comprise one or more modules or engines configured to perform the functions of the computer system 600. Each of the modules or engines can be implemented using hardware and, in some instances, can also utilize software, such as corresponding to program code and/or programs stored in the main memory 608 or secondary memory 610. In such instances, program code can be compiled by the processor device 604 (e.g., by a compiling module or engine) prior to execution by the hardware of the computer system 600. For example, the program code can be source code written in a programming language that is translated into a lower level language, such as assembly language or machine code, for execution by the processor device 604 and/or any additional hardware components of the computer system 600. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for enabling refund of a non-fungible token. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for enabling refund of a non-fungible token (NFT), comprising:
receiving, by a receiver of a processing server, a transaction message for a payment transaction;
processing, by a processor of the processing server, the payment transaction using at least the transaction message, where processing includes identification of a transaction identifier for the payment transaction;
transmitting, by a transmitter of the processing server, the transaction identifier to a first computing device;
receiving, by the receiver of the processing server, a notification message including at least the transaction identifier and a token identifier, where the token identifier is associated with the NFT;
receiving, by the receiver of the processing server, a refund request message from a second computing device, where the refund request message includes at least one of: the transaction identifier and the token identifier;
processing, by the processor of the processing server, a refund transaction for the payment transaction; and
submitting, by the transmitter of the processing server, at least the transaction identifier as input into a smart contract stored in a blockchain associated with the NFT.

2. The method of claim 1, wherein
the transaction message is an authorization request formatted according to one or more standards; and
the payment transaction is for payment from a first transaction account to a second transaction account using a fiat currency.

3. The method of claim 1, wherein
the transaction message is a data message for a blockchain transaction; and
the payment transaction is processed using one or more blockchain nodes in a blockchain network.

4. The method of claim 3, wherein the blockchain transaction is added to a second blockchain different from the blockchain associated with the NFT.

5. The method of claim 1, wherein the smart contract executes using the transaction identifier as input to reverse a prior transfer of ownership of the NFT on the blockchain associated with the NFT.

6. The method of claim 1, wherein the smart contract includes at least the transaction identifier, token identifier, buyer address, and seller address.

7. The method of claim 1, further comprising:
verifying, by the processor of the processing server, transfer of ownership of the NFT after receiving the notification message, wherein verifying transfer of ownership of the NFT includes identifying a block in the blockchain associated with the NFT that includes a blockchain data entry including at least the token identifier and the transaction identifier.

8. The method of claim 1, wherein the transaction identifier is submitted into the smart contract as input in a function call included in the smart contract.

9. A system for enabling refund of a non-fungible token (NFT), comprising:
a first computing device;
a second computing device;
a blockchain associated with the NFT; and
a processing server, the processing server including
a receiver receiving a transaction message for a payment transaction,
a processor processing the payment transaction using at least the transaction message, where processing includes identification of a transaction identifier for the payment transaction, and
a transmitter transmitting, the transaction identifier to the first computing device, wherein
the receiver of the processing server further receives
a notification message including at least the transaction identifier and a token identifier, where the token identifier is associated with the NFT, and
a refund request message from the second computing device, where the refund request message includes at least one of: the transaction identifier and the token identifier,
the processor of the processing server further processes a refund transaction for the payment transaction, and
the transmitter of the processing server further submits at least the transaction identifier as input into a smart contract stored in the blockchain associated with the NFT.

10. The system of claim 9, wherein
the transaction message is an authorization request formatted according to one or more standards; and
the payment transaction is for payment from a first transaction account to a second transaction account using a fiat currency.

11. The system of claim 9, wherein
the transaction message is a data message for a blockchain transaction; and
the payment transaction is processed using one or more blockchain nodes in a blockchain network.

12. The system of claim 11, wherein the blockchain transaction is added to a second blockchain different from the blockchain associated with the NFT.

13. The system of claim 9, wherein the smart contract executes using the transaction identifier as input to reverse a prior transfer of ownership of the NFT on the blockchain associated with the NFT.

14. The system of claim 9, wherein the smart contract includes at least the transaction identifier, token identifier, buyer address, and seller address.

15. The system of claim 9, wherein
the processor of the processing server further verifies transfer of ownership of the NFT after receiving the notification message, and
verifying transfer of ownership of the NFT includes identifying a block in the blockchain associated with the NFT that includes a blockchain data entry including at least the token identifier and the transaction identifier.

16. The system of claim 9, wherein the transaction identifier is submitted into the smart contract as input in a function call included in the smart contract.
